(19) United States
(12) Patent Application Publication
(10) Pub. No.: US 2011/0211753 A1
(43) Pub. Date: Sep. 1, 2011

(54) Automatic processing of pre-selected filters that are associated with each photo location within the template in relation to creating the photobook

(76) Inventors: Kenneth Kun Lee, Oakton, VA (US); Young il Kim, Herndon, VA (US)

(21) Appl. No.: 12/660,531

(22) Filed: Mar. 1, 2010

(51) Int. Cl. G06K 9/34; G06K 9/40

(52) U.S. Cl. 382/164; 382/260; 382/264

(57) ABSTRACT

Systems and methods are disclosed for generating a Photo Book using digital images based on pre-assigned templates and filters designed for a particular type of an event, such as weddings and portraits. The placement of the photos and subsequent processing of the photos implements pre-defined templates and pre-defined filters.

### FIELD OF THE INVENTION

The present application relates to a method and system of applying pre-defined templates and pre-defined filters to images in order to produce a photo album.

### BACKGROUND OF THE INVENTION

Digital photo images are typically generated by a digital camera. Once captured, it can be further processed using image processing software, such as Adobe Photoshop. In most cases, however, the images are stored as is or printed using a high-quality printer to be viewed. In some cases, users can create a book of photos, in which case, users may take a group of printed photos and rearrange them into a photo book. Users can also send the photos electronically to online photo processing software service through the interne. For example, the customer can use the interne browser (such as Internet Explorer) to direct the browser to a photo processing server network. The photo processing website arranges the photos per user's direction and creates a photo album that typically has multiple photos in a single page. In addition to the photo placement, further image processing takes place to enhance overall look of the album. Once the processing is finished, the final design is sent to the user in JPEG format to be printed. Or, if the user desires, the photo processing site can print the photo album and ship it to the user by Post Office or any of express shipping companies.

The process of above can be performed as shown in FIG. 1. A local computer having digital photos taken by users are transmitted electronically via network or interne to a storage server 11. Local computer 10 includes a display, a keyboard, a mouse, a printer, connection to a camera, such as through a USB port or any other means to connect external devices to the computer. The storage server 11 comprises a memory 15 to store photos that have been uploaded by users. Then, user chooses a template from a plurality of templates, selects images to desired locations within each spreads of the template to create a photo book.

However, in order to enhance the overall quality of the pictures or the photo book, the photos may be applied with special effects, such as blurring, shadow, black and white, pencil sketch, and oil paint. Adobe Photoshop or other similar software may be used to add these special effects to the pictures. This is typically performed prior to sending the photos to the storage server 11. Furthermore, the templates available in the storage server may have a limited number of options that may not meet user's expectation. The storage server 11 may also apply filter to the uploaded pictures. The user selects a desired filter function; for example, apply shadowing effect to a photo. This must be done manually by the user to each of the photos individually.

### SUMMARY OF THE INVENTION

The present invention focuses on a method and apparatus of automatically applying special effects to the images that changes the images and provide an enhanced look of the album. These special effects include, but not limited to blurring, shadow, black and white, pencil sketch, and oil paint, as well as changes in image characteristics like exposure levels. Each of these effects has parameters instructing a level of effects. In blurring function, for example, the parameter provides how much blurring should take place, anywhere from no blurring to heavy blurring.

The present invention discloses an apparatus of creating a photo album comprising a storage server comprising a first memory configured to store images or photos received from a remote computer, and a second memory configured to store pre- defined template information, and a plurality of pre-defined filter parameters; an image processing server (IPS) coupled to the storage server having a filter processor and an image placement processor; wherein the IPS retrieves pre-defined template information from the second memory, based on a selected template; wherein the IPS also retrieves at least one pre-defined filter parameter from the plurality of pre-defined filter parameters, based on the retrieved pre-defined template information; wherein the IPS applies one or more filter functions based on said at least one pre-defined filter parameter that is associated with said retrieved pre-defined template information; and wherein images applied with said one or more filter functions is provided to the remote computer.

Present invention also discloses a method of creating a photo album comprising: receiving images from a remote system; storing the received images in a first memory of a storage server; retrieving pre-defined template information from a second memory of the storage server, based on a selected template; retrieving at least one pre-defined filter parameter from a plurality of pre-defined filter parameters, based on the retrieved pre-defined template information; applying one or more filter functions, by an image processing server (IPS) that is coupled to the storage server, based on said at least one pre-defined filter parameter that is associated with said retrieved pre-defined template information; and providing the filtered images to the remote system.

The IPS retrieves the images; said pre-defined template information, and said at least one pre-defined filter parameter from the storage server before the IPS applies said one or more filter functions, wherein said pre-defined template information includes template information of a spread, and template information of an image. Pre-defined filter parameter performs at least one of blurring, shadow, black and white, pencil sketch, and oil paint functions. The template information of a spread includes information of Template identification number, Page number, Name, Category, number of images, spread width, spread height, background color, and location of sample picture. The template Information of an image includes information of image index, template identification number, spread number, image identification, spread width, spread height, image layer, image location, font style, text, angle of picture, location of original image, and filter identification.

The pre-defined filter parameters perform at least one of blurring, shadow, black and white, pencil sketch, and oil paint functions.

### BRIEF DESCRIPTION OF THE DRAWINGS

FIG. 1 is a block diagram of system for uploading images from a local computer to a server in order to create a photo album.

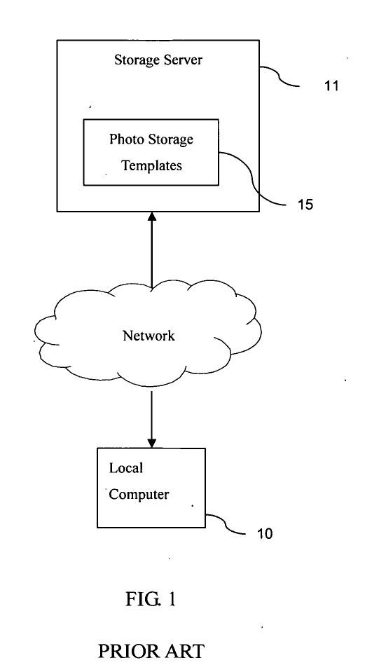

FIG. 2 is a block diagram of an embodiment of uploading images from a local computer to a server for creating a photo album with enhanced features.

FIG. 3 is a flowchart illustrating one method for processing images.

FIG. 4 is an example of a spread or page in a template.

### DETAILED DESCRIPTION

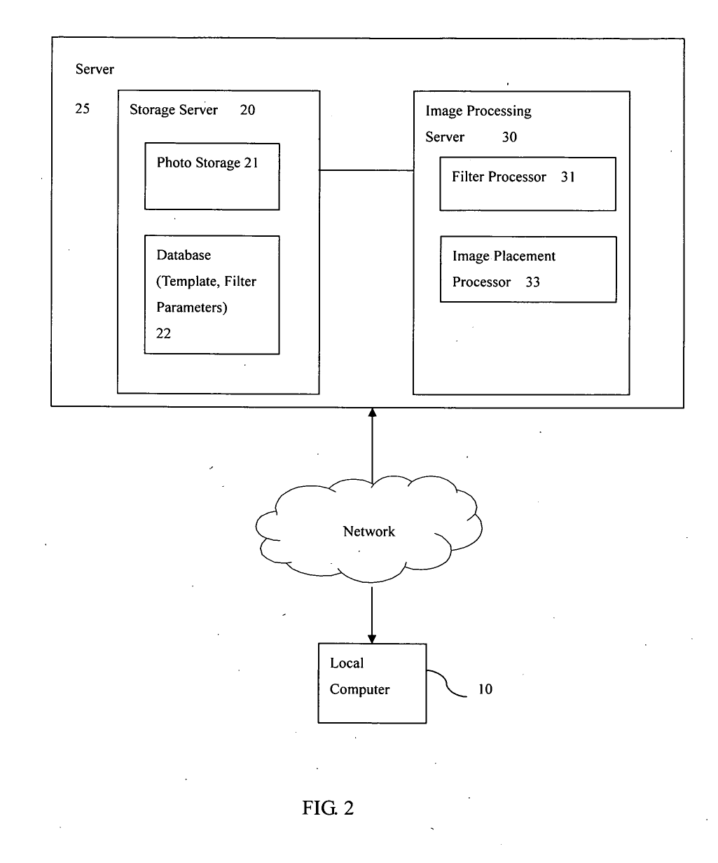

Referring to FIG. 2, a user transmits images from a local computer 10 to a server 25 through a network or the internet. The storage server comprises photo storage 21, and a memory 22. In addition to the storage server 20, image processing server (IPS) 30 is connected to the storage server. The IPS includes filter processor 31, and image placement processor 33.

Uploaded images or photos from the local computer are stored in the memory 21. Database 22 is stored with pre-defined templates, pre-defined parameters, and pre-defined filter parameters. The database and the photo storage may be any type of memory device capable of storing data.

Filter processor 31 executes different parameters by retrieving parameters stored in the database. Image Placement Processor (IPS) 33 is responsible for placement of each of the images in the template. The server 25 may be configured as a single server, wherein the server 25 may perform functions of both IPS and the storage server.

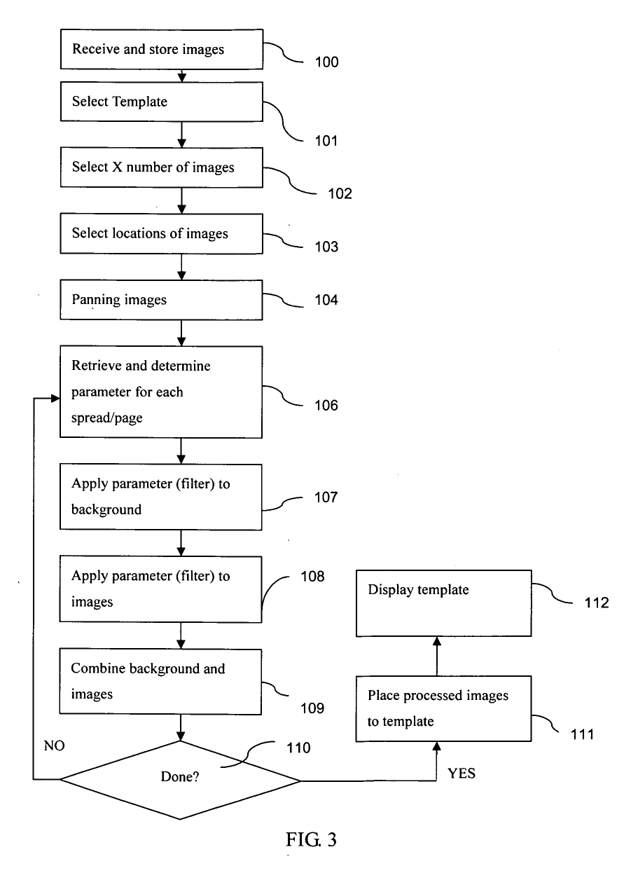

The following describes the steps performed in FIG. 2. In step 100 of FIG. 3, the storage server 20 receives images transmitted by a user from local computer 10 and stores the images in the photo storage 21. The user then selects a template from a list of different templates stored in a database or memory 22. Each of the templates includes plurality of spread and/or pages wherein each of the spread/page is designed to include different number of images. The templates are stored in the memory and are retrieved by IPS when required. The templates are pre-defined with pre-assigned parameters, such as filter, number of spreads or pages, number of images in each spread or page, location of the images, angle rotation and other parameters. By selecting a first template from a list of pre-defined templates, images are processed based on first pre-assigned parameters. And by selecting a second template, images are processed based on second pre-assigned parameters or pre-defined template information.

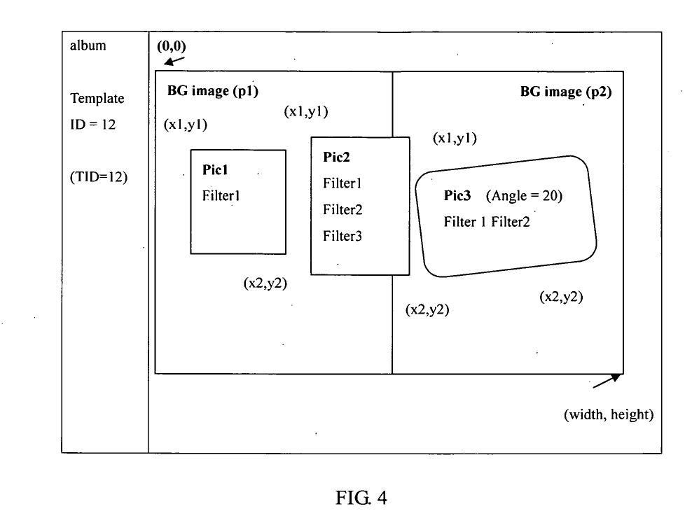

In FIG. 4, an exemplary template selected by a user shows a spread of the template supporting three images and two background images. The user can select images for each of the image locations 103. For example, a first image is selected for the image location Pic1, a second image is selected for image location Pic2, and a third image is selected for image location Pic3. As illustrated in FIG. 4, an image may also be given an angle to the image for a rotated position of the image. The positions of each of the images are identified by its width and height (x1, x2, y1, y2).

The user may also control panning and zooming functions to move the image within the image location for a desired fit 104. The spread in a template, and the page in the template are interchangeable in the embodiment depending on whether the photo book is a wedding album, in this case spreads may be used, or the photo book is a portrait, then, pages may be used.

After the user assigns images to corresponding images locations in the spread/page of the template, template information of spread/page and template information of images are processed by the IPS. IPS associates each of the images with its respective pre-defined parameters. IPS processes each of the images by spread number, image number, location (such as, top, left, box size, zoom factor), angle, font size, title, and filter parameter retrieved from the memory 22, in step 106. IPS retrieves pre-defined template information including template information of a spread and template information of an image from memory 22, based on a desired template selected by the user in step 101. The template information of a spread and the template information of an image is further described in relation to Table 1 and Table 2. While IPS retrieves the template information based on the selection made in step 101, IPS also retrieves filter parameters (including FilterID), based on the retrieved pre-defined template information. The memory 22 having stored with pre-defined template information and a plurality of pre-defined filter parameters, the selected template by the user may include template information implementing different filter parameters. Thus, corresponding filter parameters are retrieved from a pool of filter parameters stored in the memory 22, based on the template information of the selected template, in step 106.

IPS applies filter, borderline, background color, text addition, banner, shadow, and other features necessary to enhance the look of the background images 107. Each of the images assigned to the spread/page is also processed to apply filter, borderline, background color, text addition, banner, shadow, and other desirable features to enhance the look of the images 108 based on the template information that is associated with pre-defined filter parameters.

The processing of the first spread/page is complete after combining the background image and the images have been applied with the pre-defined parameters in step 109. Separate processing for the background may be optional, which then step 109 would be omitted.

IPS determines if there are more spread/page to be processed, 110. Steps 106 to 109 are repeated until all of the spread/page for the template have been completed, and then proceeds to step 111 of placing all processed spread/page into the template. The server is now ready to transmit the processed images in the form of the selected template back to user for display to the local computer 112. The final result with the filtered images in the templates is displayed to the user. As a result, the user can experience the convenience of creating a photo book by simply selecting a template, uploading images, and selecting images to its respective locations in the template.

Depending on the filter parameters of the template, IPS performs its respective filtering function. IPS performs one or more than one filter functions depending on the filter parameter of the template. And after all of the images have been processed, the filtered images are placed into its respective spreads of the templates 108.

After viewing the images, if a user wishes to view with a different template, the user may select a new template. The corresponding template information of the new template would be retrieved from the database. This new template information of the new template has different template information with its respective filter parameters that may vary from the initial template information. Thus, a first image of a first page or spread assigned with a blurring filter in the first template may be assigned with a shadowing effect to a first image of a first page or spread in a second template. This can be executed properly because each of the templates has its own corresponding template information with different pre-defined filter parameters.

Therefore, each of the pre-defined templates is associated with template information having pre-defined filter parameters, wherein the filter parameters are assigned to each of the images in the template. IPS filters the images based on the pre-defined filter parameters retrieved from database. The database stored in memory 22 includes Template Information of a spread, and Template Information of an image.

The template information stored in the database is pre-defined and is retrieved in response to user's template selection. Thus, each of the spreads and each of the images in the templates are associated with the Template Information.

The template information of a spread includes information of Template identification number (TemplateID) of a unique identification number, Page number (PageID) where the spread number starts from zero to a finite number of available spread number, Name of spread, Category of spread, Category identification number, number of images (Photos), spread width (Width), spread height (Height), background color (optional), and location of sample picture (SrcImg).

The Template Information of an image includes information of image index (Photo Index), template identification number (TemplateID), spread number (PageID), image identification (ImageID, 0 for background image, 1 for first image on the background, 2 for second image, and so on), spread width (Width), spread height (Height), image layer (Layer, 0 for bottom layer, 1 for one layer higher than bottom layer, 2 for two layers higher than bottom layer), image location (x1, y1, x2, y2), font style (FontStyleID), text, angle of image (Angle, rotation angle of image or picture), location of original image (SrcImg), and filter identification (FilterID, filter applied to the picture, using delimiter to apply multiple filters).

The embodiments of the invention have been presented for purpose of description and illustration and are not intended to be exhaustive or to limit the invention to the forms disclosed. The scope of the invention is defined by the appended claims, not the preceding disclosure.

What is claimed is:

1) An apparatus for creating a photo album, the apparatus comprising:
a storage server comprising a first memory configured to store images received from a remote system, and a second memory configured to store pre-defined template information and a plurality of pre-defined filter parameters;
an image processing server (IPS) coupled to the storage server having a filter processor and an image placement processor;
wherein the IPS retrieves the pre-defined template information from the second memory, based on a selected template;
wherein the IPS also retrieves at least one pre-defined filter parameter among the plurality of pre-defined filter parameters, based on the retrieved pre-defined template information;
wherein the IPS applies one or more filters based on said at least one pre-defined filter parameter that is associated with said retrieved pre-defined template information; and
wherein images applied with said one or more filters and placed into the selected template are provided to the remote system.

2) The apparatus of claim 1, wherein the IPS retrieves the images, said pre-defined template information, and said at least one pre-defined filter parameter from the storage server before the IPS applies said one or more filters.

3) The apparatus of claim 1, wherein said pre-defined template information includes template information of a spread, and template information of an image.

4) The apparatus of claim 1, wherein said at least one pre-defined filter parameter performs at least one of blurring, shadow, black and white, pencil sketch, and oil paint functions.

5) The apparatus of claim 1, wherein said pre-defined template information includes template information of a spread, and template information of an image, and wherein said template information of a spread includes information of Template identification number, Page number, Name, Category, number of images, spread width, spread height, background color, and location of sample picture.

6) The apparatus of claim 1, wherein said pre-defined template information includes template information of a spread, and template information of an image, and wherein said template information of an image includes information of image index, template identification number, spread number, image identification, spread width, spread height, image layer, image location, font style, text, angle of picture, location of original image, and filter identification.

7) A method of creating a photo album, the method comprising:
receiving images from a remote system;
storing the received images in a first memory of a storage server;
retrieving pre-defined template information from a second memory of the storage server, based on a selected template;
retrieving at least one pre-defined filter parameter from a plurality of pre-defined filter parameters, based on the retrieved pre-defined template information;
applying one or more filters, by an image processing server (IPS) that is coupled to the storage server, based on said at least one pre-defined filter parameter that is associated with said retrieved pre-defined template information;
placing filtered images into the selected template; and
providing the placed images to the remote system.

8) The method of claim 7, wherein the IPS retrieves the images, said pre-defined template information, and said at least one pre-defined filter parameter from the storage server before the IPS applies said one or more filters.

9) The method of claim 7, wherein said pre-defined template information includes template information of a spread, and template information of an image.

10) The method of claim 7, wherein said at least one pre-defined filter parameter performs at least one of blurring, shadow, black and white, pencil sketch, and oil paint functions.

11) The method of claim 7, wherein said pre-defined template information includes template information of a spread, and template information of an image, and wherein said template information of a spread includes information of Template identification number, Page number, Name, Category, number of images, spread width, spread height, background color, and location of sample picture.

12) The method of claim 7, wherein said pre-defined template information includes , template information of a spread, and template information of an image, and wherein said Template Information of an image includes information of image index, template identification number, spread number, image identification, spread width, spread height, image layer, image location, font style, text, angle of picture, location of original image, and filter identification.
